(19) United States
(12) Patent Application Publication
(10) Pub. No.: US 2022/0109728 A1
(43) Pub. Date: Apr. 7, 2022

(54) COMPOSITE ENERGY SENSOR BASED ON ARTIFICIAL INTELLIGENCE

(71) Applicant: Electronics and Telecommunications Research Institute, Daejeon (KR)

(72) Inventors: Tai-yeon KU, Daejeon (KR); Wan Ki PARK, Daejeon (KR)

(21) Appl. No.: 17/492,162

(22) Filed: Oct. 1, 2021

(30) Foreign Application Priority Data
Oct. 5, 2020 (KR) 10-2020-0128094
Jan. 22, 2021 (KR) 10-2021-0009372

(51) Int. Cl. H04L 29/08; G06N 20/00; G06N 5/04

(52) U.S. Cl. CPC H04L 67/12; G16Y 20/30; G06N 5/04; G06N 20/00

(57) ABSTRACT

A composite energy sensor is disclosed. The composite energy sensor may support decision-making by identifying a situation related to overall energy use, and provide sensor precision that is at a level of replacing a high-cost sensor through combination of low-cost sensor data.

### CROSS-REFERENCE TO RELATED APPLICATIONS

This application claims the benefit of Korean Patent Application No. 10-2020-0128094 filed on Oct. 5, 2020, and Korean Patent Application No. 10-2021-0009372 filed on Jan. 22, 2021, in the Korean Intellectual Property Office, the entire disclosures of which are incorporated herein by reference for all purposes.

### BACKGROUND

### 1. Field of the Invention

One or more example embodiments relate to an artificial intelligence (AI)-based composite energy sensor, and more particularly, to a sensor technology for more efficient management and optimal operation of energy in an energy management system (EMS) environment.

### 2. Description of Related Art

In general, sensors and sensor-related technologies are being used in most industries through the stages of a chip, a package, a unit, and a system. A sensor industry includes a material industry for manufacturing sensors, a device industry in which unique functions are implemented using materials, and a unit and system-type industry in which multiple devices are used and assembled. Here, the sensors, which are core components that diversify and modernize functions of most set products, are used as a core part in most industries and play an important role in enhancing competitiveness of each industry. It is suitable for nurturing a global specialized company because material technology, design technology, process technology, and the like are different depending on an application field due to small quantity batch production, and win-win cooperation with sensor-demanding companies, which are mainly large companies, is important in this field.

The sensors, which are core components of electronic devices, automobiles, and the like, belong to a technology-intensive industry with a large front-to-back linkage effect, and have a small quantity batch production structure, and thus have high barriers to entry. As a key item that leads a paradigm change of the fourth industrial revolution, the sensors are expected to reach the age of 10 trillion production, and combine with artificial intelligence (AI), big data, cloud, and the like to support construction of new industrial platforms such as smart factories, robots, the Internet of things (IoT), and the like.

Despite an optimistic market outlook based on a quantitative increase of the sensor industry, domestic sensor-demanding companies mainly procure sensor demands from overseas companies due to reliability of domestic products, problems in performance of advanced sensors, and the like. The domestic companies are sandwiched between the United States, Germany, and Japan with advanced technologies and China with price competitiveness, due to lack of technical skills for advanced sensors and weak price competitiveness of general sensors. The sensor-demanding companies import and use about 90% of domestic demands from overseas for reasons of performance and reliability, and domestic sensor companies are in a vicious cycle of avoiding innovation because they are small-scale companies and lack technical skills.

Among sensor products, smartphone image sensors (domestic self-sufficiency rate of about 50%), chemical sensors for measuring gas and water quality (5-10%), and optical sensors for diagnosing building safety using optical fibers (5-10%), and the remaining sensors (pressure, inertia, magnetism, image, and radar) are almost entirely import-dependent. Even when new products are developed, it is difficult to enter a market due to lack of a basis for reliability evaluation and lack of marketing capabilities. There is no domestic institution that is capable of supporting testing for reliability evaluation of sensor products and technologies, so it is dependent on foreign institutions. A level of domestic sensor technology is low, and in particular, a level of advanced sensor technology is more insufficient.

Accordingly, domestic sensor technology development focuses on the development of sensors used for smart home/home appliances, smart factories, smart cities, smart logistics, and the like, or production unrelated to energy, IoT devices/products, environment, security, and the like. It is possible to preoccupy domestic related technologies and lead the market by developing an AI composite energy sensor system for the purpose of energy reduction specialized for an energy management system (EMS). The domestic sensor companies need to focus on a sensor technology that is capable of sustainably growing to a level of hatching by importing and packaging sensor chips due to lack of technical skill and the like.

It is necessary to secure global market competitiveness and lead the four seasons sensor market through the development of an AI composite energy sensor capable of recognizing additional situations by combining heterogeneous sensor data, getting away from a sensor miniaturization technology.

### SUMMARY

Example embodiments provide an artificial intelligence (AI)-based composite energy sensor technology that combines sensor data measured by heterogeneous or multiple types of sensors to construct big data information for energy reduction of an energy management system (EMS).

Example embodiments generate state information on energy use by combining sensor data, predict an energy consumption influence factor that influences energy use depending on the state information and an optimal environmental factor, and provide a result of prediction to the EMS.

Example embodiments provide AI sensing information that is directly usable in a composite sensor system-based application by combining sensor data and performing data learning through big data and AI analysis.

According to an aspect, there is provided a composite energy sensor including a composite sensor unit configured to integrate a single sensor pre-installed in a building and a composite sensor that is in the form of AI, a learning environment unit configured to lighten a learning engine for providing an online learning function depending on integration of the single sensor and the composite sensor, and a learning inference unit configured to infer state information on energy use using the lightened learning engine.

The composite sensor unit may be configured to integrate sensor data collected by the single sensor pre-installed in the building and sensor data provided by the composite sensor so as to be used as basic information for a composite sensor function.

The composite sensor unit may be configured to integrate a composite sensor that shares at least one piece of sensor data collected by the single sensor via a network.

The composite sensor unit may be configured to integrate a composite sensor that provides sensor precision by applying AI learning inference on sensor data collected by the single sensor.

The composite sensor unit may be configured to integrate a composite sensor that provides new sensing information through AI learning inference using sensor data collected by the single sensor.

The composite sensor unit may be configured to integrate a composite sensor that provides necessary information required for energy management in interoperation with a wearable device or an Internet of things (IoT) device.

The learning inference unit may be configured to sense an influence factor that influences energy use depending on the learning engine, and provide information on each situation depending on the sensed influence factor.

According to another aspect, there is provided a composite energy sensor system including a single sensor configured to collect sensor data related to energy consumption from a building, and a composite energy sensor device configured to provide sensing information required for energy management based on an AI technology by combining the single sensor and the composite sensor to each other.

The composite energy sensor device may be configured to perform physical or logical combination between sensor data collected by the single sensor and sensor data provided by the composite sensor.

The composite energy sensor device may be configured to lighten a learning engine for providing an online learning function depending on integration of the sensor data of the single sensor and the sensor data of the composite sensor.

The composite energy sensor device may be configured to sense an influence factor that influences energy use depending on the learning engine by inferring state information on energy use using the lightened learning engine.

The composite energy sensor device may include a composite sensor that shares at least one piece of sensor data collected by the single sensor via a network.

The composite energy sensor device may include a composite sensor that provides sensor precision by applying AI learning inference on sensor data collected by the single sensor.

The composite energy sensor device may include a composite sensor that provides new sensing information through AI learning inference using sensor data collected by the single sensor.

The composite energy sensor device may include a composite sensor that provides necessary information required for energy management in interoperation with a wearable device or an IoT device.

Additional aspects of example embodiments will be set forth in part in the description which follows and, in part, will be apparent from the description, or may be learned by practice of the disclosure.

According to example embodiments, a composite energy sensor may replace a high-cost sensor through combination of low-cost sensor data, or provide indirect and virtual sensing of a point that is difficult to sense due to harsh environments (high temperature, high pressure, vibration, narrow space, and the like), thereby obtaining effects of replacing a physical sensor and reducing costs.

According to example embodiments, the composite energy sensor may provide real-time data monitoring, analysis, and a danger alarm service so that sensor data abnormality/control malfunction is quickly determined and processed, and thus collection and analysis of safety-related data may be performed through convergence sensor data, thereby preventing a negligent accident.

According to example embodiments, the composite energy sensor may provide a technology for constructing big data information for energy reduction of an EMS by combining sensor data measured by heterogeneous or multiple types of sensors.

According to example embodiments, the composite energy sensor may provide a technology of combining sensor data and generating state information on energy use to predict an energy consumption influence factor that influences energy use depending on the state information and an optimal environmental factor.

According to example embodiments, the composite energy sensor may provide AI sensing information that is directly usable in a composite sensor system-based application by combining sensor data and performing data learning through big data and AI analysis.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a technical conceptual diagram of an artificial intelligence (AI)-based composite energy sensor according to an example embodiment;

FIG. 2 is a diagram illustrating definition of a technology of a three-level composite energy sensor depending on a technology shape according to an example embodiment;

FIG. 3 is a diagram illustrating five service types operating at a sensor level among three levels of a composite energy sensor according to an example embodiment; and

FIGS. 4A and 4B are diagrams illustrating technical components related to an AI-based composite energy sensor according to an example embodiment.

### DETAILED DESCRIPTION

Hereinafter, example embodiments will be described in detail with reference to the accompanying drawings.

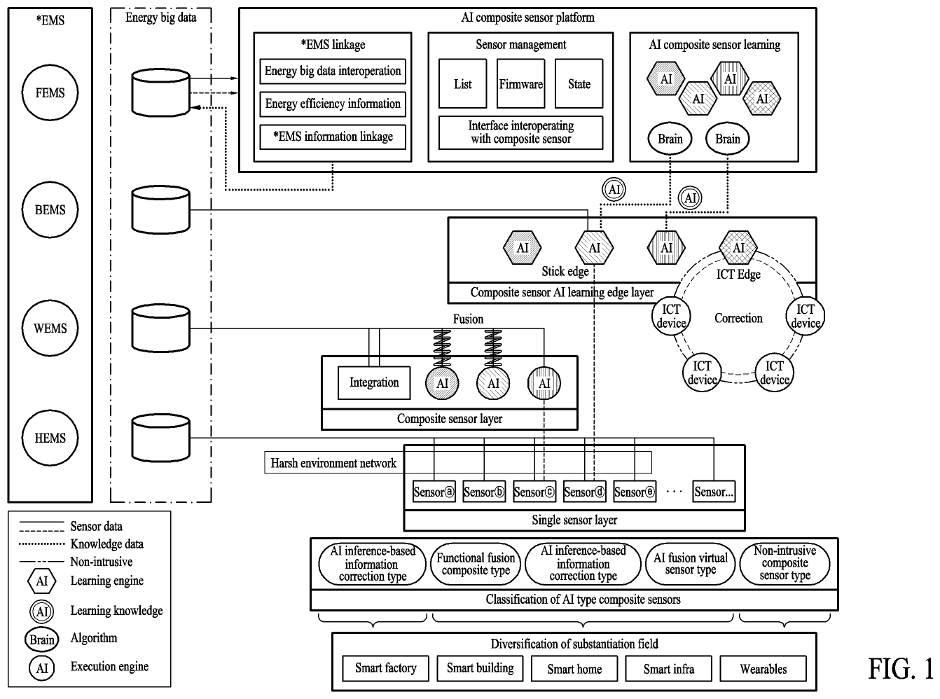

FIG. 1 is a technical conceptual diagram of an artificial intelligence (AI)-based composite energy sensor according to an example embodiment.

Referring to FIG. 1, the AI-based composite energy sensor may perform logical combination or physical combination on single sensors installed in a building and sensor data monitored by the single sensors. The composite energy sensor may perform AI-based data learning based on the single sensors and the sensor data on which logical combination or physical combination is performed, thereby providing supplementary sensor information for management and optimal operation of energy of the building. In addition, the composite energy sensor may predict an energy consumption influence factor and an optimal environmental factor required for energy management of the building, thereby determining and processing a malfunction of a sensor in advance while reducing an energy usage of the building.

For example, the AI-based composite energy sensor may be an AI-type composite sensor device that improves a function/performance of sensing influence factors for energy consumption and energy management and providing information by combining sensors and fusing AI learning/inference functions in a field of consumption and operation of energy of an x energy management system (XEMS).

Here, the xEMS may be a management target depending on an EMS that collects various types of energy in the entire process in which energy is produced, supplied and consumed, and supports efficient management to be performed in terms of energy and cost, or may be a system that integrates separate names depending on scope or purpose. For example, the xEMS may be a system collectively referred to for each management technology such as a factory energy management system (FEMS), a building energy management system (BEMS), and a home energy management system (HEMS) depending on an energy consumption area.

The example embodiments define an AI-based composite energy sensor and propose a technique for combining the composite energy sensor to be applicable depending on a management technology of the xEMS.

More specifically, the composite energy sensor may be a sensor that specializes in the xEMS and has a purpose of reducing energy. The composite energy sensor may support decision-making by identifying a situation related to overall energy use, rather than by simply specifying an energy usage of the existing EMS, and may provide sensor precision that is at a level of replacing a high-cost sensor through combination of low-cost sensor data.

To this end, in the example embodiments, the composite energy sensor may be classified into three layers by combining single sensors pre-installed in the building and fusing a data learning inference function of AI. Hereinafter, the classified three layers may be defined as \textcircled{1} a composite sensor layer, \textcircled{2} an energy device layer, and \textcircled{3} a server layer.

\textcircled{1} Composite Sensor Layer

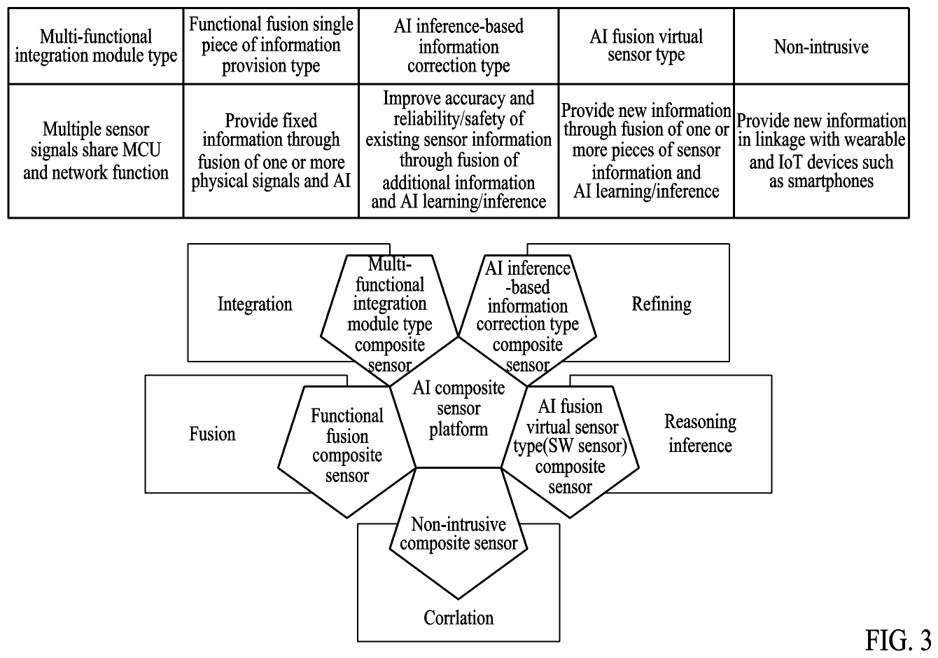

The composite sensor layer may be a layer that integrates single sensors installed in a building and sensor data collected by the single sensors. In addition, the composite sensor layer may be a layer that integrates sensors that provide an AI-based service as well as the single sensors. The AI-based service may be the service type of FIG. 3.

\textcircled{2} Energy Device Layer

The energy device layer may be a layer that provides an online learning function that is performable not only by a high-spec computing device but also by a low-spec computing device in consideration of a type, specification, and the like of a computing device that performs a learning engine. In other words, the energy device layer may provide a low-cost AI learning environment that lightens the learning engine to enable AI learning to be performed even by the low-spec computing device.

\textcircled{3} Server Layer

The server layer may be a layer that performs learning/inference about a situation related to overall energy use using a learning engine.

The composite energy sensor may generate new state information through combination of sensor data measured by various single sensors depending on each layer classified and recognize a situation by itself to generate big data information for energy reduction of the EMS.

At this time, the composite energy sensor may sense an influence factor that influences energy use, not simple energy usage-oriented data required by the EMS, and may generate and provide a level of information in which each situation depending on the sensed influence factor is recognizable.

For example, when the composite energy sensor is used as an occupancy sensor used in the BEMS, the composite energy sensor may perform composite determination as to whether a user is present in the building, the number of occupants present in each space in the building, and a state of each user, and may provide a result of the determination. In other words, the composite energy sensor may combine sensor data monitored by a single sensor pre-installed in the building, and perform AI-based data analysis and learning. The composite energy sensor may predict an energy consumption influence factor and an optimal environmental factor through AI-based data analysis and learning, thereby recognizing each situation related to occupancy and providing information on each situation.

In addition, the composite energy sensor may sense an influence factor that influences energy use, not simple energy usage-oriented data required by the EMS, and may provide information in a situational awareness level. In other words, the composite energy sensor may provide an AI fusion technology that presents information at a level required by an application through combination of sensors and data learning so as to solve a limitation of extracting different levels of information of the pre-installed single sensor.

The composite energy sensor, which is a sensor that analyzes a level of sensor precision and senses at a lower cost compared to a commercial sensor and within a tolerance range, may provide sensor data suitable for a specification of an application that requires real-time so as to quickly perform calculation/analysis/processing at an edge level.

Finally, the composite energy sensor proposed in the example embodiments may derive new information through combination of heterogeneous or homogeneous various sensors, and enable efficient energy management through big data and AI analysis. In addition, the composite energy sensor may derive AI sensing information in which various pieces of information or situations may be recognized based on a composite sensor system compared to an existing sensor system that measures only one value.

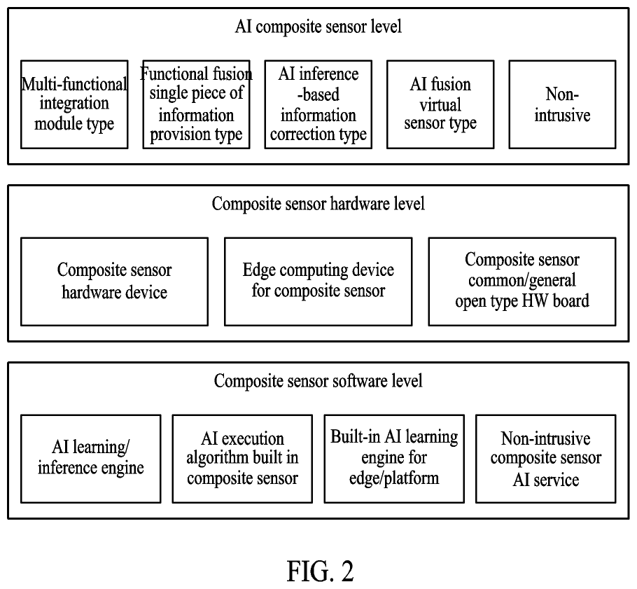

FIG. 2 is a diagram illustrating definition of a technology of a three-level composite energy sensor depending on a technology shape according to an example embodiment.

Referring to FIG. 2, the composite energy sensor may be classified into three levels depending on a technology shape used in the three layers to correspond to the three layers illustrated in FIG. 1. Hereinafter, the classified three levels may be defined as \textcircled{1} a sensor level, \textcircled{2} an hardware (HW) product level, and \textcircled{3} an software (SW) product level.

\textcircled{1} Sensor Level

The sensor level may be a level indicating a service type operating as a composite energy sensor. Here, the service type may be classified into \textcircled{a} a multi-functional integration type, \textcircled{b} a function fusion type, \textcircled{c} an AI inference information-correction type, \textcircled{d} an AI fusion virtual sensor type, and \textcircled{e} a non-intrusive type. A detailed description thereof will be described with reference to FIG. 3.

\textcircled{2} HW Product Level

The HW product level may be a level at which a composite sensor hardware device for using a composite energy sensor, an edge computing device for a composite sensor, and the like are derived.

\textcircled{3} SW Product Level

The SW product level may be a level at which an AI learning/inference technology operated at a server level and an AI inference algorithm mounted and executed on a composite sensor are derived. In addition, at the SW product level, the lightened AI learning/inference technology and a composite sensor composition service may be derived.

FIG. 3 is a diagram illustrating five service types operating at a sensor level among three levels of a composite energy sensor according to an example embodiment.

Referring to FIG. 3, the composite energy sensor may be a sensor including a service type that is classified into \textcircled{a} a multi-functional integration type, \textcircled{b} a function fusion type, \textcircled{c} an AI inference information-correction type, \textcircled{d} an AI fusion virtual sensor type, and \textcircled{e} a non-intrusive type. Each service type may be defined as follows.

\textcircled{a} The multi-functional integration type, which has a concept of integration between single sensors, may be defined as a service type in which multiple sensors share a processor and network function to provide efficiency.

\textcircled{b} The function fusion type may be defined as a service type that creates fixed new information through combination of multiple pieces of sensor information and fusion of AI.

\textcircled{c} The AI inference information-correction type may be defined as a service type that enhances incomplete existing sensor information by adding other information or fusing AI.

\textcircled{d} The AI fusion virtual sensor type may be defined as a service type related to a software composite sensor that creates new information by using multiple pieces of sensor information.

\textcircled{e} The non-intrusive type may be defined as a service type that creates necessary information in linkage with a wearable device or Internet of things (IoT) device without installing an additional new sensor. New information may be created using signal information of non-intrusive wearable and IoT devices.

In the composite energy sensor including these five service types, a sensing information inference algorithm learned by machine learning may be executed by the composite sensor itself. In addition, the composite energy sensor may be provided with an online AI learning function in interoperation with an edge device or a server.

Furthermore, the composite energy sensor, which is a user composition service that provides the above-described five services, may induce a user to directly create sensor information.

In addition, each of the above-described sensors may be defined as indicated in Table 1 below.

TABLE 1

| Classification of sensors | | | Feature |
|---|---|---|---|
| Single sensor | | | A sensor that provides a simple single |
| | | | piece of information |
| | | | Used as a base technology for a |
| | | | composite sensor function |
| | | | Example: temperature, humidity, CO2, |
| | | | illuminance, fine dust, gas, wind |
| | | | speed/direction, dust, and the like |
| Com- | Multi-functional | | A composite sensor in which multiple |
| posite | integration type | | sensor signals share a single MCU and |
| sensor | composite sensor | | network function |
| | | | Improvement in efficiency of a processor |
| | | | and a network resource |
| | | | Example: a composite sensor in which a |
| | | | temperature sensor, a humidity sensor, |
| | | | a CO2 sensor, an illuminance sensor, a |
| | | | fine dust sensor, a gas sensor, a wind |
| | | | speed/direction sensor, an occupancy |
| | | | sensor, and the like share one MCU |
| | AI | Functional | A composite sensor that provides a single |
| | type | fusion | piece of information by fusing single or |
| | | composite | multiple signals and an AI function |
| | | type | Example: A sensor that provides |
| | | | occupancy information in which people |
| | | | counter + infrared sensor + AI |
| | | | are fused |
| | | AI | A composite sensor that adds other sensor |
| | | inference- | information to existing sensor information |
| | | based | and improves accuracy, and |
| | | information | reliability/stability of the existing sensor |
| | | correction | information by fusing AI learning |
| | | type | inference |
| | | | Example: A composite sensor that |
| | | | provides AI inference type flow |
| | | | information of a flow sensor + a |
| | | | pressure sensor |
| | | AI fusion | A composite sensor that provides new |
| | | virtual | information through AI learning inference |
| | | sensor | by fusing single or multiple pieces of |
| | | type | sensor information |
| | | (SW sensor) | Example: a virtual sensor, a software |
| | | | sensor, a rotating machine state/lifetime |
| | | | predictive maintenance composite sensor, |
| | | | and the like |
| | | Non- | A complex sensor that provides new |
| | | intrusive | information in linkage with a wearable |
| | | composite | device and a IoT device such as a |
| | | sensor type | smartphone, a smart watch, and the like. |
| | | | Example: A composite sensor that |
| | | | provides situational awareness information |
| | | | using smartphone sensor information |

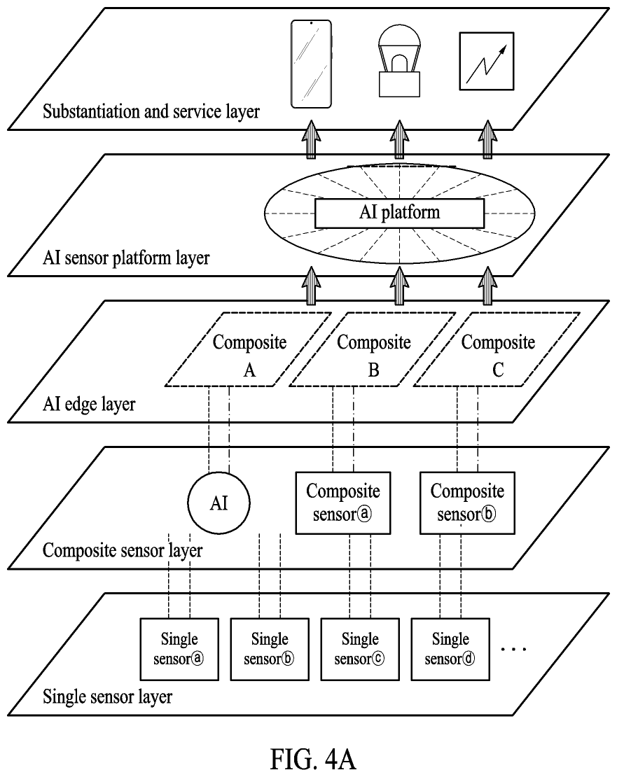

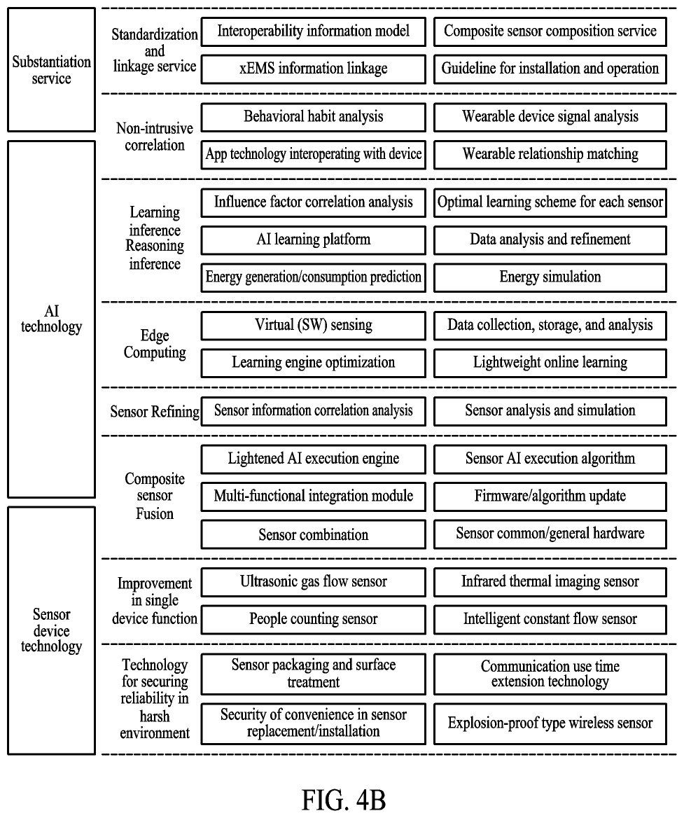

FIGS. 4A and 4B are diagrams illustrating technical components related to an AI-based composite energy sensor according to an example embodiment.

Referring to FIG. 4, the AI-based composite energy sensor may be hierarchized into five layers: \textcircled{1} a single sensor, \textcircled{2} a composite sensor, \textcircled{3} an AI edge, \textcircled{4} an AI sensor platform, and \textcircled{5} a service layer depending on the technical components. Here, the composite sensor, the AI edge, and the AI sensor platform may be collectively referred to as a composite energy sensor layer. The composite energy sensor may be defined as indicated in Table 1 below.

A sensor device technology performed by the single sensor and the composite sensor may secure installation convenience and reliability in a harsh environment, and may include a hardware technology for single device function improvement and the composite sensor.

An AI technology performed in the composite energy sensor layer may include edge computing and an AI learning inference technology in the server. In addition, an AI type composite sensor management platform may include a sensor management function, and an upgrade technology of a firmware and AI execution algorithm. In an AI learning platform, a customized learning engine may be developed in accordance with a driving environment and a sensor characteristic of an AI type composite sensor, and a composite sensor execution algorithm package may be created through AI learning based on collected data. In addition, the AI learning platform may provide an online learning function using the collected data. An edge computing composite sensor and a lightweight learning engine may not use server-level computing power, and may enable a low-cost AI learning environment that lightens a learning engine so that even a low-spec edge computing device performs AI learning.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A composite energy sensor comprising:
a composite sensor unit configured to integrate a single sensor pre-installed in a building and a composite sensor that is in the form of artificial intelligence (AI);
a learning environment unit configured to lighten a learning engine for providing an online learning function depending on integration of the single sensor and the composite sensor; and
a learning inference unit configured to infer state information on energy use using the lightened learning engine.

2. The composite energy sensor of claim 1, wherein the composite sensor unit is configured to integrate sensor data collected by the single sensor pre-installed in the building and sensor data provided by the composite sensor so as to be used as basic information for a composite sensor function.

3. The composite energy sensor of claim 1, wherein the composite sensor unit is configured to integrate a composite sensor that shares at least one piece of sensor data collected by the single sensor via a network.

4. The composite energy sensor of claim 1, wherein the composite sensor unit is configured to integrate a composite sensor that provides sensor precision by applying AI learning inference on sensor data collected by the single sensor.

5. The composite energy sensor of claim 1, wherein the composite sensor unit is configured to integrate a composite sensor that provides new sensing information through AI learning inference using sensor data collected by the single sensor.

6. The composite energy sensor of claim 1, wherein the composite sensor unit is configured to integrate a composite sensor that provides necessary information required for energy management in interoperation with a wearable device or an Internet of things (IoT) device.

7. The composite energy sensor of claim 1, wherein the learning inference unit is configured to sense an influence factor that influences energy use depending on the learning engine and provide information on each situation depending on the sensed influence factor.

8. A composite energy sensor system comprising:
a single sensor configured to collect sensor data related to energy consumption from a building; and
a composite energy sensor device configured to provide sensing information required for energy management based on an AI technology by combining the single sensor and the composite sensor to each other.

9. The composite energy sensor system of claim 8, wherein the composite energy sensor device is configured to perform physical or logical combination between sensor data collected by the single sensor and sensor data provided by the composite sensor.

10. The composite energy sensor system of claim 9, wherein the composite energy sensor device is configured to lighten a learning engine for providing an online learning function depending on integration of the sensor data of the single sensor and the sensor data of the composite sensor.

11. The composite energy sensor system of claim 10, wherein the composite energy sensor device is configured to sense an influence factor that influences energy use depending on the learning engine by inferring state information on energy use using the lightened learning engine.

12. The composite energy sensor system of claim 8, wherein the composite energy sensor device includes a composite sensor that shares at least one piece of sensor data collected by the single sensor via a network.

13. The composite energy sensor system of claim 8, wherein the composite energy sensor device includes a composite sensor that provides sensor precision by applying AI learning inference on sensor data collected by the single sensor.

14. The composite energy sensor system of claim 8, wherein the composite energy sensor device includes a composite sensor that provides new sensing information through AI learning inference using sensor data collected by the single sensor.

15. The composite energy sensor system of claim 8, wherein the composite energy sensor device includes a composite sensor that provides necessary information required for energy management in interoperation with a wearable device or an IoT device.
